(19) United States
(12) Patent Application Publication
(10) Pub. No.: US 2004/0084922 A1
(43) Pub. Date: May 6, 2004

(54) Vehicle equipped with an umbrella-receiving apparatus

(76) Inventors: Kyung-Oh Park, Seoul (KR); Sung-Hee Ryu, Seoul (KR); Jong-Min Choi, Seoul (KR)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 10/379,477

(22) Filed: Mar. 4, 2003

(30) Foreign Application Priority Data
Oct. 31, 2002 (KR) 10-2002-0067173

(51) Int. Cl. B60R 7/12

(52) U.S. Cl. 296/37.13

(57) ABSTRACT

The present invention provides a vehicle for conveniently receiving an umbrella, including a vehicle body forming a passenger compartment and interior trim attached to the vehicle body in an inside of the passenger compartment, wherein a hollow for receiving an umbrella is formed in the interior trim.

### FIELD OF THE INVENTION

The present invention relates to a vehicle, and more particularly, to a vehicle equipped with an umbrella-receiving apparatus.

### BACKGROUND OF THE INVENTION

Vehicles are widely used for transportation of passengers and freight, and a variety of apparatuses for convenience of people using the vehicles, such as an air conditioning system and a heating system, have been developed and utilized.

Vehicles are preferably run regardless of the weather. In the case that it rains or snows, a driver and/or a passenger (referred to as “occupant” hereinafter) carrying an umbrella must put their umbrella inside the vehicle when entering the vehicle. According to the prior art, vehicles are not provided with appropriate apparatus for receiving such umbrellas inside the vehicles.

Therefore, in most cases, the occupant usually just throws their umbrella on the floor of the passenger compartment, or gets into the vehicle after putting the umbrella in a cargo area such as a trunk of the vehicle.

In these cases, the passenger compartment and/or a cargo area easily get soiled, and furthermore, harmful mold can easily grow on the floor due to dampness.

If an occupant puts the umbrella in a cargo area, they must move back and forth along the vehicle, and they can get wet due to rain or snow while doing so.

The information disclosed in this Background of the Invention section is only for enhancement of understanding of the background of the invention and should not be taken as an acknowledgement or any form of suggestion that this information forms the prior art that is already known to a person skilled in the art.

### SUMMARY OF THE INVENTION

Therefore, the motivation for the present invention is to provide an umbrella-receiving apparatus to a vehicle.

An exemplary vehicle useful with the present invention includes a vehicle body and interior trim attached to the vehicle body, wherein a hollow for receiving an umbrella is formed in the interior trim.

In more detail, an exemplary vehicle useful with the present invention includes a vehicle body forming a passenger compartment, and interior trim attached to the vehicle body inside the passenger compartment, wherein a hollow for receiving an umbrella is formed in the interior trim.

The hollow for receiving an umbrella may be formed at a door panel attached to a door, or it may be formed at a dashboard.

That is, according to a further preferred embodiment, the vehicle body comprises a door for allowing an occupant access to the passenger compartment, and the interior trim is a door panel attached to the door.

According to another preferred embodiment, the interior trim may be a dashboard installed within the passenger compartment. In this case, it is preferable that the hollow for receiving an umbrella is formed forward from the dashboard. It is further preferable that the vehicle body comprises a fire wall disposed forward of the dashboard and the hollow for receiving an umbrella penetrates the fire wall.

Regardless of where the hollow for receiving an umbrella is formed, it is preferable that a cover for covering the hollow is further included, in a vehicle according to the present invention.

Furthermore, the hollow for receiving an umbrella preferably has an open at its lower portion, and the hollow for receiving an umbrella is preferably formed at a predetermined angle with respect to horizontal.

According to a further preferable embodiment, a ventilation duct for ventilating air of the passenger compartment is further included in a vehicle, and the hollow for receiving an umbrella is connected to the ventilation duct.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 is a schematic diagram of a vehicle equipped with an umbrella-receiving apparatus according to a first preferred embodiment of the present invention;

FIG. 2 is a perspective view of a vehicle equipped with an umbrella-receiving apparatus according to a second preferred embodiment of the present invention; and

FIG. 3 is a side view of a vehicle equipped with an umbrella-receiving apparatus according to a second preferred embodiment of the present invention.

### DETAILED DESCRIPTION OF THE PREFERRED EMBODIMENTS

A preferred embodiment of the present invention will hereinafter be described in detail with reference to the accompanying drawings.

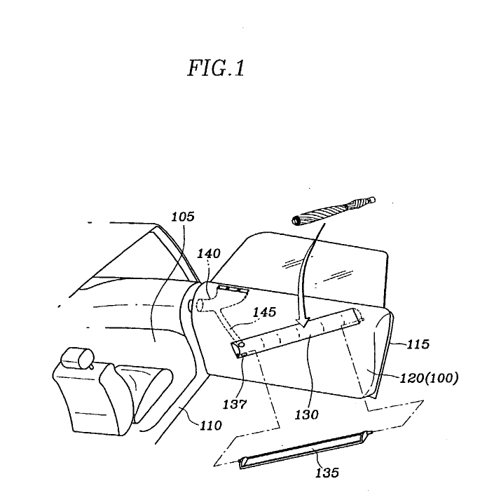

FIG. 1 is a schematic diagram of a vehicle equipped with an umbrella-receiving apparatus according to a first preferred embodiment of the present invention.

As shown in FIG. 1, a vehicle according to a first embodiment of the present invention includes a vehicle body 110 forming a passenger compartment 105, and interior trim 100 attached to the vehicle body 110 inside the passenger compartment 105, wherein a hollow 130 for receiving an umbrella is formed in the interior trim 100.

The vehicle body 110 includes a door 115 for allowing an occupant access to the passenger compartment 105. FIG. 1 shows that the interior trim 100 in which the hollow 130 is formed is a door panel 120, attached to the door 115, and the door panel 120 may be one at a driver's side or at rear passenger seats. The hollow 130 is formed toward an interior side of the door panel 120, and it has sufficient dimensions such as length and depth to receive long objects such as an umbrella.

A cover 135 is arranged with the hollow 130 for receiving an umbrella such that the hollow 130 can be covered with the cover 135, thereby holding the umbrella in place. FIG. 1 shows a cover 135 combined with the hollow 130 with hinges. The cover 130 also improves the appearance of the passenger compartment 105 since an umbrella in the hollow 130 cannot be seen.

FIG. 1 only shows that the cover 135 is formed along the hollow 130 for receiving an umbrella, but the position and shape of the cover 135 may be obviously designed in a variety of fashions. For example, it may be such that a cover is arranged at an end of the hollow 130, and an umbrella is put in place through the end of the hollow 130 with the cover.

A vehicle is usually equipped with a ventilation system for ventilating air of the passenger compartment, and such a ventilation system includes a plurality of ventilation ducts. Such a ventilation duct may also be disposed between the door panel 120 and the door 115 in order to prevent fog or frost from forming on the side window.

According to a first embodiment of the present invention, as shown in FIG. 1, a ventilation duct 140 for ventilating air of the passenger compartment is disposed between the door panel 120 and the door 115. The ventilation duct 140 and the hollow 130 for receiving an umbrella are connected by a connecting pipe 145.

Therefore, air can be ventilated to the hollow 130 for receiving an umbrella, and accordingly an umbrella in the hollow 130 can be dried quickly.

In addition, according to a first embodiment of the present invention, a through hole 137 is formed at a lower portion in the inside of the hollow 130. Therefore, the hollow 130 for receiving an umbrella has an opening in downward direction.

Liquids such as water drops from an umbrella in the hollow 130 can drain by way of the through hole 137, to between the door panel 120 and the door 115. As usual, an outlet opening (not shown) is formed at a lower portion of the door 115, and accordingly the liquid drained from the hollow 130 for receiving an umbrella can be drained out of the vehicle.

The hollow 130 for receiving an umbrella is formed at a predetermined angle with respect to horizontal such that both draining of the liquid from the hollow 130 and ventilation of air from the ventilation duct 140 are optimized.

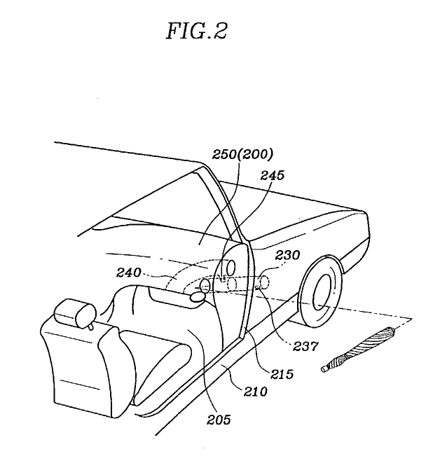

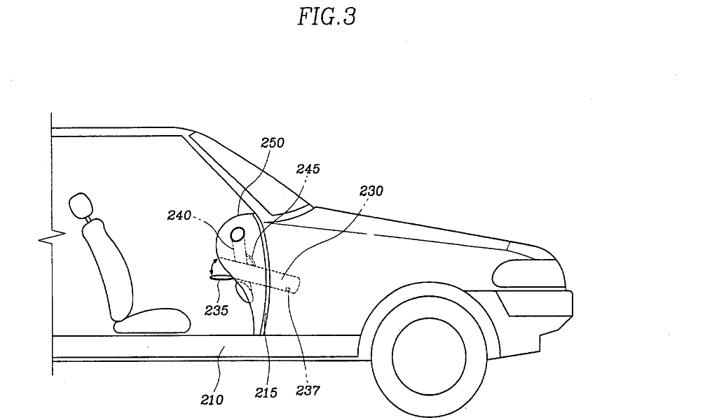

FIG. 2 is a perspective view of a vehicle equipped with an umbrella-receiving apparatus according to a second preferred embodiment of the present invention, and FIG. 3 is a side view of a vehicle equipped with an umbrella-receiving apparatus according to the second preferred embodiment.

As shown in FIG. 2 and FIG. 3, a vehicle according to the second embodiment of the present invention includes a vehicle body 210 forming a passenger compartment 205, and interior trim 200 attached to the vehicle body 210 inside the passenger compartment 205, wherein a hollow 230 for receiving an umbrella is formed in the interior trim 200.

FIGS. 2 and 3 show that the hollow 230 for receiving an umbrella is formed at a dashboard 250 installed at a forward location within the passenger compartment 205.

In more detail, the vehicle body 210 includes a fire wall 215 disposed forward of the dashboard 250, separating the passenger compartment 205 from the engine compartment, and the dashboard 250 is installed on the fire wall 215. The hollow 230 for receiving an umbrella is formed forward from the dashboard 250. The hollow 230 is formed penetrating the fire wall 215 in the case that the gap between the fire wall 215 and the dashboard 250 at the position where the hollow 230 is formed is insufficient for the length of the hollow 230 to receive an umbrella.

A cover 235 is arranged with the hollow 230 for receiving an umbrella such that the hollow 230 can be covered with the cover 235. The cover 235 holds the umbrella in place. The cover 235 also improves the appearance of the passenger compartment 205 since an umbrella in the hollow 230 cannot be seen.

According to a second preferred embodiment of the present invention, as shown in FIG. 2 and FIG. 3, a ventilation duct 240 for ventilating air of the passenger compartment 205 is disposed between the dashboard 250 and the fire wall 215. The ventilation duct 240 and the hollow 230 for receiving an umbrella are connected by a connecting pipe 245.

Therefore, air can be ventilated to the hollow 230 for receiving an umbrella, and accordingly an umbrella in the hollow 230 can be dried quickly.

In addition, according to a second embodiment of the present invention, a through hole 237 is formed at a lower portion in the inside of the hollow 230. Therefore, the hollow 230 for receiving an umbrella is open at its downward portion.

Liquids such as water drops from an umbrella in the hollow 230 can drain from the hollow 230 by way of the through hole 237 to an engine compartment (not shown). As a result, the liquid drained from the hollow 230 for receiving an umbrella can be drained out of the vehicle.

The hollow 230 for receiving an umbrella is formed at a predetermined angle with respect to horizontal such that both draining of the liquid from the hollow 230 and ventilation of air from the ventilation duct 240 are optimized.

According to a preferred embodiment of the present invention, the passenger compartment can be kept clear of water drops or moisture from an umbrella since an occupant can put their umbrella in a specifically designed holder. As a result, gathering of harmful microorganisms such as mold can be minimized. In addition, the body or clothing of an occupant can be kept from getting wet.

In the case that hollows for receiving an umbrella are formed at door panels, an occupant can easily store their umbrella regardless of their seat. In addition, in the case that the hollow for receiving an umbrella is formed at a dashboard, loss of passenger room by the hollow can be minimized.

Since the hollow for receiving an umbrella is open at its downward portion, liquids can be easily drained to the outside of the vehicle, and drying of an umbrella in the hollow can be accelerated since a ventilation duct and the hollow are connected by a connecting pipe.

Exhaust of the liquid from the hollow 230 is accelerated and ventilation of air from the ventilation duct 240 is improved, since the hollow for receiving an umbrella is formed at a predetermined angle with respect to horizontal.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

Throughout this specification and the claims which follow, unless explicitly described to the contrary, the word “comprise” or variations such as “comprises” or “comprising” will be understood to imply the inclusion of stated elements but not the exclusion of any other elements.

What is claimed is:

1. A vehicle comprising:
a vehicle body; and
interior trim attached to the vehicle body,
wherein a hollow for receiving an umbrella is formed in the interior trim.

2. A vehicle comprising:
a vehicle body forming a passenger compartment; and
interior trim attached to the vehicle body inside the passenger compartment,
wherein a hollow for receiving an umbrella is formed in the interior trim.

3. The vehicle of claim 2, wherein the vehicle body comprises a door for allowing an occupant access to the passenger compartment, and the interior trim is a door panel attached to the door.

4. The vehicle of claim 2, wherein the interior trim is a dashboard installed within the passenger compartment, and the hollow for receiving an umbrella is formed forward from the dashboard.

5. The vehicle of claim 4, wherein the vehicle body comprises a fire wall disposed forward of the dashboard, and the hollow for receiving an umbrella penetrates the fire wall.

6. The vehicle of claim 2, further comprising a cover for covering the hollow for receiving an umbrella.

7. The vehicle of claim 3, further comprising a cover for covering the hollow for receiving an umbrella.

8. The vehicle of claim 4, further comprising a cover for covering the hollow for receiving an umbrella.

9. The vehicle of claim 2, wherein the hollow for receiving an umbrella has an opening formed at its lower portion.

10. The vehicle of claim 3, wherein the hollow for receiving an umbrella has an opening formed at its lower portion.

11. The vehicle of claim 4, wherein the hollow for receiving an umbrella has an opening formed at its lower portion.

12. The vehicle of claim 5, wherein the hollow for receiving an umbrella has an opening formed at its lower portion.

13. The vehicle of claim 2, wherein the hollow for receiving an umbrella is formed at a predetermined angle with respect to horizontal.

14. The vehicle of claim 3, wherein the hollow for receiving an umbrella is formed at a predetermined angle with respect to horizontal.

15. The vehicle of claim 4, wherein the hollow for receiving an umbrella is formed at a predetermined angle with respect to horizontal.

16. The vehicle of claim 5, wherein the hollow for receiving an umbrella is formed at a predetermined angle with respect to horizontal.

17. The vehicle of claim 2, further comprising a ventilation duct for ventilating air of the passenger compartment, wherein the hollow for receiving an umbrella is connected to the ventilation duct.

18. The vehicle of claim 3, further comprising a ventilation duct for ventilating air of the passenger compartment, wherein the hollow for receiving an umbrella is connected to the ventilation duct.

19. The vehicle of claim 4, further comprising a ventilation duct for ventilating air of the passenger compartment, wherein the hollow for receiving an umbrella is connected to the ventilation duct.

20. The vehicle of claim 5, further comprising a ventilation duct for ventilating air of the passenger compartment, wherein the hollow for receiving an umbrella is connected to the ventilation duct.
